(19) United States
(12) Patent Application Publication
(10) Pub. No.: US 2026/0336614 A1
(43) Pub. Date: Oct. 29, 2026

(54) METHOD FOR GUIDING A VEHICLE, CONTROLLER, VEHICLE, AND COMPUTER PROGRAM

(71) Applicant: Continental Autonomous Mobility Germany GmbH, Ingolstadt (DE)

(72) Inventor: Stefan Feick, Oberhausen (DE)

(73) Assignee: Continental Autonomous Mobility Germany GmbH, Ingolstadt (DE)

(21) Appl. No.: 19/107,378

(22) PCT Filed: Aug. 9, 2023
(86) PCT No.: PCT/DE2023/200161

§ 371 Date: Feb. 27, 2025

(30) Foreign Application Priority Data
Aug. 31, 2022 (DE) 10 2022 209 045.4

(51) Int. Cl. B60W 30/12; B60W 50/00; B62D 15/02

(52) U.S. Cl. CPC B60W 30/12; B62D 15/025; B60W 2050/002; B60W 2050/0031; B60W 2520/10; B60W 2552/30

(57) ABSTRACT

A method for guiding a vehicle is disclosed and described herein. A manipulated variable is determined by a lateral control as a function of a lateral deviation error which describes a lateral offset of the vehicle relative to a specified target trajectory. A lateral position of the vehicle is adjusted to the target trajectory as a function of the manipulated variable. At least one calibration value is additionally applied to the manipulated variable, wherein the calibration value is determined by at least one calibration function at least partly as a function of an integration over time of the lateral deviation error.

### CROSS-REFERENCE TO RELATED APPLICATIONS

The present application is a National Stage Application under 35 U.S.C. § 371 of International Patent Application No. PCT/DE2023/2001615 filed on Aug. 9, 2023, and claims priority from German Patent Application No. 10 2022 209 045.4 filed on Aug. 31, 2022, in the German Patent and Trademark Office, the disclosures of which are herein incorporated by reference in their entireties.

### TECHNICAL FIELD

The technical field relates to a method for guiding a vehicle and an associated controller, vehicle, and computer program.

### BACKGROUND

Vehicles can be equipped with systems or functions for automatic lane guidance. These make it possible to automatically set the lateral position of the vehicle during driving according to a specified trajectory. The lateral position of the vehicle, that is to say, the sidewise position of the vehicle in a lane, can be modified or adjusted to a target position, by way of example, by automated steering movements.

As a general rule, such lane-keeping functions utilize environmental data which have been obtained with the aid of sensors for detecting the environment of the vehicle, for example cameras, radar, or lidar systems, and/or with the aid of a navigation system, by way of example a GPS, in order to guide vehicles along a planned trajectory. The trajectory is designed, by way of example, for high ride comfort, that is to say, it does not contain any sharp or rapid alterations in the vehicle lateral position if at all possible. The guidance of the vehicle along such a trajectory is, as a general rule, embodied as a control in which at least the lateral deviation of the vehicle from the planned trajectory is continuously determined, wherein control commands of suitable size and direction are output, by way of example, to an electric steering assistance system of the vehicle as a function of the deviation. Criteria for assessing the control quality of such systems are, for example, the amplitude and the dynamics of the lateral control deviation and the frequency of jerky movements on a steering wheel of the vehicle. Ideally, the lateral control error is zero for all driving situations, so that the steering interventions due to the lane guidance or the steering wheel movements which arise are exclusively caused by the course of the planned trajectory.

The efficiency of such lane guidance depends on the quality of the used sensors and actuators of the vehicle. To a certain extent, the efficiency of an entire system can in principle be enhanced by deploying multiple sensors or multiple actuators and/or by deploying suitable software measures. This also applies in particular to driver assistance systems as they represent functions for lane-keeping assistance.

Nevertheless, sensor errors of the sensors, i.e., any deviation of a sensor signal from its physical correspondence, influence the character of the control and, therefore, also the control quality of the lane guidance of the vehicle, in particular due to the error propagation which occurs. Depending on the sensor information, sometimes different and sometimes overlapping functional chains come into effect.

An imaging error of the camera which detects the lane markings can, for example, lead to the determined curvature of the road deviating from the real curvature, which represents a so-called ground truth error. As a general rule, the lane guidance incudes at least one controller and/or at least one pre-control which adapts the lateral vehicle position as a function of the determined road curvature. Curvature information which describes the road curvature, often determined in a forecast point of the vehicle, can be used in order to calculate the steering angle required for the respective curvature via an inverted vehicle model and to introduce this, by way of example, within the framework of a pre-control, to a steering angle controller as a target steering angle component.

If the curvature information now has an offset compared with the actual curvature due to an error, the pre-controlled target steering angle likewise contains an offset proportion which acts, so to speak, as a disturbance on the lateral control. The effect of this is that, when lane-keeping assistance is activated, the vehicle does not follow the trajectory as expected, but rather, depending on the embodiment of the lateral control or of a trajectory tracking controller,—i.e., use of controller types with or without stationary accuracy—has a permanent lateral offset relative to the planned trajectory or at least causes a transient veering-out before the vehicle then follows the planned trajectory after an equalization process has subsided. The permanent or transient lateral offset can have an adverse effect on the ride comfort, which can have a detrimental effect on the driver's acceptance of the driving assistance system.

As a general rule, the degree of the imaging errors of the camera varies over the service life of the driver assistance system, since calibration routines of the camera are typically carried out continuously. This means that, depending on the status of the camera calibration, the level of an offset of the curvature pre-control and, consequently, also the degree of the adverse effect of the vehicle lateral guidance are time-variant, even though the transmission properties of the camera and, therefore, also the offset of the curvature do not alter by leaps and bounds, but rather alter in a band-limited or creeping manner.

The steering angle mostly represents a significant auxiliary or control variable within a guided assistance system, so that routines are often also deployed to calibrate a steering angle offset. Due to the finite accuracy of the calibration routines, the determined steering angle offset always has an uncompensated proportion. Said remaining offset error in a steering angle signal can have multiple causes. Typical calibration routines rely, by way of example, on the signal of a yaw rate sensor or of wheel speed sensor technology. Errors in said sensors such as, for example, an offset and/or a linearity error, or in the case of wheel speed sensors, speed differences due to different pressures on the tires on an axle then propagate to the determined steering angle offset. The effects of steering angle offsets can be compared to the case described above of a curvature offset: here as well, when lane-keeping assistance is activated, the vehicle does not follow the specified trajectory as expected, but rather, depending on the embodiment of the lateral control or of the trajectory tracking controller, has a permanent or transient lateral offset relative to the planned trajectory, with the detrimental effects on the comfort and the acceptance of the driver assistance system.

This applies equally to an uncompensated offset of a front axle steering angle and of a rear axle steering angle.

The sensor signals for the yaw rate, the front and rear axle steering angles as well as for lateral acceleration can, in particular, also be used for further functions within the vehicle, which can likewise have an influence on a lateral position or the lateral guidance of the vehicle. For example, said sensor signals can also be used for estimating disturbing forces and load torques acting on the vehicle as well as for estimating a side slip angle of the vehicle, for example as a consequence of a road incline and/or thanks to crosswind. In such a case, the determined variables then likewise contribute to the vehicle lateral guidance as a target steering angle component in the course of an introduction of disturbance variables, wherein in particular corresponding offsets of the sensor signals likewise propagate as errors to the target steering angle and, consequently, the lateral position of the vehicle. Here as well, the consequence is an undesirable transient or permanent lateral offset of the guided vehicle.

A method for steering angle offset compensation in a motor vehicle by means of a vehicle model is known from DE 10 2008 026 233 B4. A yaw rate is calculated as a function of a detected steering angle, a vehicle speed and an assumed steering wheel angle offset. Further, the calculated yaw rate is compared with a measured yaw rate, wherein the difference thereof forms an error equation, from which a steering wheel angle offset is then established, which is fed back into the vehicle model in order to iteratively establish and compensate for the steering wheel angle offset.

Such an offset calibration of a yaw rate or of a lateral acceleration has a finite accuracy and constantly lags behind the real offset, as a result of which additional, undesirable steering interventions can be produced even in the presence of this.

As such, it is desirable to improve the accuracy of the lane guidance of a vehicle and therefore the ride comfort and the acceptance of the assistance system by the driver, including under the influence of offset errors.

### SUMMARY

In one embodiment of a method of guiding a vehicle, at least one calibration value is additionally applied to the manipulated variable, wherein the calibration value is determined by at least one calibration function at least partly as a function of an integration over time of the lateral deviation error.

The vehicle lateral position is adjusted with the aid of the sum of the manipulated variable and the at least one calibration value. Depending on the configuration of the lateral control and/or of the lane guidance, it is possible that further components are applied to the manipulated variable, in addition to the at least one calibration value.

The manipulated variable, to which the calibration value is applied, influences the lateral position of the vehicle. The manipulated variable can be, by way of example, a target steering angle. This can be specified, by way of example, at a steering angle interface with electric power steering. Alternatively, it is also possible to specify the manipulated variable at a torque interface of the EPS, which brings about a steering torque or a steering angle.

The calibration value is determined by the calibration function, in particular depending on the algebraic sign and the amplitude of the integrated lateral deviation error in such a way that the calibration value is constantly aimed at reducing the current lateral deviation error when it is applied to the manipulated variable. That is to say that, by applying the calibration value to the manipulated variable, the target steering angle is successfully corrected or compensated by the lateral deviation error which is integrated over time.

The lateral deviation error describes the lateral or sidewise offset of the vehicle, that is to say, an offset in the lateral direction of the vehicle, relative to the specified target trajectory. The lateral deviation error can thus also be referred to as a lateral offset or as a lateral deviation. Consequently, the lateral deviation error expresses, in other words, the current deviation of an actual vehicle position from a desired vehicle target position described by the target trajectory. The establishment of the lateral offset of the vehicle relative to the target trajectory can be based on an agreed point along the longitudinal axis of the vehicle. In this way, the lateral offset can be advantageously based on the geometric center of the rear axle or of the front axle or also on any further forecast point along the vehicle's longitudinal axis.

The lateral deviation error can be continuously determined, by way of example, as a function of sensor data from at least one environmental sensor of the vehicle. The environmental sensor can be, by way of example, a camera, a lidar sensor, a radar sensor and/or an ultrasonic sensor. Additionally or alternatively, the lateral deviation error can also be determined as a function of position data of a navigation system. The lateral deviation error has a time-dependent value which is integrated by the calibration function.

The lateral controller deployed for the lateral control can be, by way of example, a trajectory tracking controller or can include such a trajectory tracking controller. The calibration function, which can also be referred to as centering calibration or centering function, is present in addition to the trajectory tracking control and consequently forms a coordinated or higher-level control circuit which likewise influences the manipulated variable and, consequently, likewise the lateral position of the vehicle. In particular, the dynamics of the calibration function are clearly less than the dynamics of the lateral control, so that the lateral deviation error integrated over time only influences the manipulated variable very slowly.

By way of example, an integrator with a comparatively small integration coefficient can be used as a calibration function or as a basic calculation rule for determining the calibration value, as a result of which an integration of the lateral deviation error with low dynamics and, consequently, also an influence of the calibration value with low dynamics is brought about.

According to the disclosure, the at least one calibration function can in each case be embodied as an I element or as a PT1 element. Compared to a pure I element, a PT1 element likewise has an integrating property but, advantageously, does not require any of the measures necessary for I elements to limit the integrator state. This advantage is to be weighed up against the disadvantage of the non-stationary, exact compensation of the offset variables in the respective application by making use of the parametrization degrees of freedom of the PT1 element.

The adaptation dynamics of the calibration value is in particular dimensioned such that it lies in the order of magnitude of the alteration dynamics of the offset errors. One measure of this is, for example, the largest expected, temperature-related offset drift of the sensors used for the lateral control, converted to the corresponding steering angle plane. The advantage of this is that no overshoot of the lateral control arises which, for example, with higher dynamics of the calibration function, would lead to an intervention of further compensation functions acting on the steering angle, such as compensation for a road side inclination and/or crosswind compensation.

By using the at least one calibration function or by applying the at least one calibration value to the manipulated variable, it is advantageously achieved that offset errors which continuously affect the lane guidance also partly or completely diminish over time or said offset errors are partly or completely compensated over time. Compensation functions acting on the steering angle are often not continually active. For example, as a general rule, a lane-keeping function does not become effective until it has been activated by the driver. If the compensation functions deduce a presumed control error due to the offset errors at the time of their activation, the compensation functions will output manipulated variables in an attempt to reduce the control errors. Depending on the dynamics of the compensation functions, this can lead to jerky steering movements. By compensating for the offset errors in advance, the occurrence of jerky steering movements to correct a built-up lateral offset can consequently be advantageously avoided, as a result of which the comfort for an occupant is improved when lane guidance is activated. This also improves the acceptance of the lane guidance or of the driver assistance system which brings about the lane guidance.

In summary, the basic idea of the higher-level calibration function can also be interpreted as a fixed value control of low dynamics with a target value of zero for the lateral deviation error. In terms of its effect, it reduces the sum of all direct and indirect offset influences of the sensors used in the network on the lateral offset of the vehicle during automatic lateral or lane guidance.

According to the disclosure, it can be provided that the time constant of the calibration function is larger than the dominant time constant of the lateral control, in particular at least by a factor of 2. The time constant of the calibration function may also be larger than the dominant time constant of the lateral control at least by a factor of 5, at least by a factor of 10, at least by a factor of 100 or at least by a factor of 1000. In principle, even larger differences between the time constants are conceivable. A calibration function which is realized, for example, as an I element can have, by way of example, an integration coefficient between 0.01 degrees/(m*s) and 0.00005 degrees/(m*s) inclusive.

In an exemplary configuration, it can be provided that an integration value of the calibration function is determined by the integration over time of the lateral deviation error, wherein the integration value is retained when the lane guidance is deactivated and is used as the starting value of the integration over time of the lateral deviation error when the lane guidance is reactivated.

The integration value describes the total value which has been formed by the integration over time of the lateral deviation error up to a point in time allocated to the integration value. That is to say that the integration value represents the result of the integration over time of the lateral deviation error up to this point in time for a specific point in time. If multiple calibration functions are deployed, an integration value allocated to the respective calibration function is formed in particular for each of the calibration functions separately. The at least one integration value can be saved in a retrievable manner, by way of example, in a storage device of a computing device which carries out the method such as a controller.

The state of the calibration function, that is to say, the state of an integrator forming the calibration function or of a comparable functional unit, is not reset, that is to say, by way of example, in the current ignition cycle of the vehicle, but rather is maintained even when the driver assistance is repeatedly deactivated and activated or during driver interventions. A resetting of the integrator, in the event of an implausible activity being recognized, for example in the event of a jump in the output of one or more offset calibrations of the vehicle sensors being recognized or communicated, or in the event of a request via a diagnostic interface of the vehicle, can, however, additionally be likewise provided. It is possible that the integration value is also retained beyond one ignition cycle of the vehicle, i.e., over multiple trips.

According to the disclosure, it can be provided that the lateral control includes a pre-control, wherein the pre-control determines a pre-control variable as a function of a measured and/or predicted curvature value of a road used by the vehicle, wherein the manipulated variable contains the pre-control variable as a component.

A measured curvature value and/or a predicted curvature value can in particular be determined from the sensor data from one or more of the environmental sensors of the vehicle. The pre-control can in particular calculate the steering angle required for the respective curvature with the aid of the measured curvature value and/or the predicted curvature value over an inverted vehicle model, and introduce this as a pre-control variable, by way of example, to the manipulated variable of a trajectory tracking controller of the lateral control. The vehicle model alters its transmission behavior as a function of the vehicle speed. It is obvious from this that an error in the measured curvature value has an influence on the lateral guidance of the vehicle, which is dependent on the vehicle speed.

According to the disclosure, it can be provided that the pre-control is effected as a function of a vehicle model which describes an inherent steering gradient of the vehicle, wherein the inherent steering gradient is adapted during the operation of the vehicle as a function of at least one vehicle parameter, in particular a vehicle mass and/or a tire stiffness.

During cornering of the vehicle, the lateral deviation error as a consequence of a pre-control error depends not only on an offset error in the curvature, but rather also on the inaccuracy of the saved vehicle parameters, in particular on uncertainties of an inherent steering gradient used in the vehicle model. An error or a deviation in the inherent steering gradient has the effect of a disturbance on the lateral control of the vehicle and thus also proportionally causes an additional lateral deviation error which leads to an incorrect deflection of the calibration value generated by the calibration function. In such a case, the calibration value does not therefore only react to sensor offset variables. However, as long as the errors or deviations in the inherent steering gradient are limited, their impact is only small due to the low dynamics of the calibration function.

In order to also avoid the influence of larger errors and/or deviations in the inherent steering gradient, this can be adapted, in particular continuously, as a function of at least one vehicle parameter. The adaptation can, by way of example, be effected as a function of a current vehicle mass, a current tire stiffness of one or more tires of the vehicle and/or further parameters of the vehicle.

In one configuration, it can be provided that the integration over time of the lateral deviation error is effected with a weighting factor, in particular a coefficient of integration, which depends on a speed of the vehicle and/or increases as the amount of the lateral deviation error rises.

Whilst using a constant integration coefficient, for example, can represent an easy-to-realize compromise for the entire speed range of the vehicle, the advantage of using a speed-dependent coefficient of integration or a comparable weighting factor of the integration is that a better compensation of speed-dependent offsets is possible. The influence of offset variables on the lateral deviation error can arise, for example, due to the commonly used setting of the control parameters of the lateral control as a function of the driving speed of the vehicle. As a result, the disturbance compensation property of the lateral control also alters and, therefore, also the effect of sensor offset variables on the lateral deviation error. In order to take account of this circumstance, the integration over time can likewise be made dependent, by using a speed-dependent weighting factor such as a speed-dependent integration coefficient, on the driving speed. Advantageously, an ideal, individually adapted calibration dynamic can consequently be achieved for each driving speed range.

Additionally or alternatively, it is possible that the weighting factor is also made dependent on the amount of the lateral deviation error, that is to say, on the value of a lateral deviation error to be integrated and/or of a previously integrated lateral deviation error, wherein a greater weighting is effected for larger values of the lateral deviation error. To this end, an allocated weighting factor or integration coefficient can be determined, by way of example, for the current lateral deviation error in each case, as a function of a non-linear allocation rule and/or of one or more thresholds for the lateral deviation error and enlisted during the integration over time of the lateral deviation error. The calibration speed can be effectively increased by progressively weighting the amount of the lateral deviation error, that is to say, by increasing the weighting factor or coefficient of integration as the amount of the lateral deviation error increases.

To this end, by way of example, the integration coefficient and therefore the adaption rate of the calibration function can also be switched over between two or also more values, wherein the integration coefficient is chosen to be higher for larger absolute values of the lateral deviation error. Advantageously, doubling the coefficient of integration or the integration constant for an amount of the lateral deviation error of more than 0.2 m already leads to an effective, faster initial adaptation to the existing offset situation when the driver assistance function is started.

Even in the event that the vehicle has an additional sensor offset calibration function which remedies a recognized offset drift of at least one sensor of the vehicle after a confirmation time or a debounce time has elapsed with a sudden correction of the respective offset, an increase in the adaptation rate of the centering calibration, depending on the amount of the lateral deviation error, can ensure a faster alignment to the new offset situation. This becomes all the more significant the longer the debounce time of the sensor offset calibration functions is since, during this period, compensation is already increasingly effected by the calibration function due to the integration over time of the lateral deviation error, which compensation has to be integrated back again after a signal update of the sensor offset calibration functions has been effected. Advantageously, the speed of the equalization process can be increased by using a larger weighting or a larger integration value.

Since sudden corrections of a sensor offset calibration function of the vehicle directly lead to a lateral jerk of the guided vehicle, which depends on the jump height, it can be provided for a vehicle which includes a control device configured to perform a method as described herein that all of the sensor offset calibration functions in the vehicle do not make an alteration by leaps and bounds to the respective offset, but rather only within a limited band.

According to the disclosure, it can be provided that the integration over time of the lateral deviation error by the calibration function is stopped when:
the or an integration value of the calibration function determined by the integration over time of the lateral deviation error corresponds to a specified limit value,
the or a measured and/or predicted curvature value of the or of a road used by the vehicle exceeds a specified threshold,
a curvature value of the target trajectory exceeds a specified threshold,
the product of the square of the current vehicle speed and the curvature value of the road exceeds a specified threshold, and/or
the product of the square of the current vehicle speed and the curvature value of the target trajectory exceeds a specified threshold.

The contribution of the calibration value to the manipulated variable can be restricted to a limit value by at least temporarily stopping the integration over time of the lateral deviation error in the calibration function, or by restricting a total value of the integration to the limit value. The limit value represents a maximum amplitude and can, by way of example, be governed by a sum of the maximum influences of all of the offset variables on the steering angle target value and the actual steering angle value. The provision of measures for avoiding integrator windup effects in the calibration function can be advantageously dispensed with thanks to this procedure.

Alternatively to limiting the integrator value to a limit value, the calibration function can also include a low-pass filter function, for example a PT−1 filter. As a result, windup effects can also be avoided. It is true that a sensor offset cannot be completely compensated for, the centering accuracy achieved by the calibration function can nevertheless be sufficient.

Additionally or alternatively, it is possible that the integration over time of the lateral deviation error by the calibration function is stopped when the or a measured and/or predicted curvature value of the or of a road used by the vehicle exceeds a specified threshold and/or when a curvature value of the target trajectory exceeds a specified threshold.

During cornering of the vehicle, the lateral deviation error as a consequence of a possible error in the pre-control depends not only on an offset error in the curvature, but rather also on the inaccuracy of the saved vehicle parameters, in particular on uncertainties of an inherent steering gradient of the vehicle. An erroneous curvature pre-control of the vehicle can have the effect of disturbing the lateral control of the vehicle and, as a result, proportionally cause an additional lateral deviation error. Said additional lateral deviation error can lead to an erroneous intervention of the calibration function, which can be advantageously avoided or reduced by a suspension of the calibration function or at least the integrating over time of the lateral deviation error by the calibration function.

The effect of an error in the curvature pre-control on the driving operation or the lateral position of the vehicle can in particular depend on the vehicle speed. In order to consider said speed dependence, it can thus be provided that the integration over time of the lateral deviation error by the calibration function is stopped when the product of the square of the current vehicle speed and the curvature value of the road exceeds a specified threshold, and/or when the product of the square of the current vehicle speed and the curvature value of the target trajectory exceeds a specified threshold.

In one configuration, the integration over time of the lateral deviation error is stopped and/or the application of the calibration value to the manipulated variable is suspended when a steering torque is generated above a specified threshold and/or a steering torque which enlarges the current lateral deviation error is generated by a steering intervention by a driver of the vehicle. As a result, it can be advantageously avoided that lateral deviation errors which arise as a result of a deliberate driving intervention do not find their way into the calibration value determined by the calibration function since said lateral deviation errors do not hark back to an offset of a sensor or the like, which is to be compensated for. An influence on the calibration value of a lateral offset relative to the target trajectory which is deliberately induced by a driver and which does not originate in the lane guidance function is consequently advantageously avoided.

According to the disclosure, it can be provided that during a steering intervention by a driver of the vehicle which generates a steering torque which reduces the current lateral deviation error the integration over time of the lateral deviation error is effected at least for a specified period of time with an increased weighting, in particular with an increased coefficient of integration.

When the driver makes a steering intervention of his own accord, which generates a steering torque which acts in the same direction as the calibration value generated by the calibration function, this can be viewed as a confirmation of the adaptation direction of the calibration function. Using an increased weighting or an increased integrating value in this case advantageously makes possible improved calibration dynamics by the calibration function. From the driver's perspective, this manifests itself in such a way that the driver can displace the vehicle's course laterally more towards the center of the lane and the course remains there in future, even if he withdraws the corrective steering torque.

In one configuration, it can be provided that multiple integrating functions are used, wherein a different speed interval is assigned to each of the integrating functions, wherein the integrating functions each integrate the lateral deviation error over time at a speed of the vehicle which lies within the speed interval assigned to each of them, wherein the calibration value of the integration function, the speed interval of which includes the current speed of the vehicle, or a total calibration value determined as a function of the calibration value is introduced to the manipulated variable.

As described above, the effect of offset variables on the lateral deviation error is partly dependent on the speed of the vehicle. This applies, for example, to the offset errors which are contained in an output variable of a sensor disturbance compensation or to the offset error which is an integral part of a curvature pre-control. In order to keep the lateral deviation error as low as possible, the calibration value introduced to the manipulated variable can also be determined depending on the speed. In particular, due to the high integration time constants and the associated low dynamics, the adaptation of the calibration value of an individual calibration function to the altered driving speed can take a relatively long time, during which the accuracy of the lane guidance can be reduced.

In order to take account of this circumstance, it is advantageous to use a plurality of calibration functions instead of an individual calibration function for the entire vehicle speed range. Each of the calibration functions can determine its own calibration value and, in particular, also store it separately from the further calibration values. The ability to store the calibration values separately, for example by saving them in a non-volatile memory means that they can then be continuously extended by the integration over time during continued operation or that all of the states of the plurality of calibration functions can be initialized separately when the vehicle ignition is restarted.

The entire range of the possible vehicle speed can in particular be subdivided into multiple sub-intervals, each of which only covers a limited speed range and each of which is allocated a dedicated calibration function. The calibration value of the calibration function, which is allocated to the speed interval in which the current speed of the vehicle lies, is applied to the manipulated variable. Consequently, only an individual calibration function is always active, while the remaining calibration functions, including in particular the integration over time of the lateral deviation error by the further calibration functions, are stopped or an input signal of zero is introduced to the inputs thereof. By contrast, the calibration function which is active in each case can be supplied with the current lateral deviation error. A weighting of the lateral deviation error can be effected with a constant weighting factor or coefficient of integration or via a weighting factor or coefficient of integration which depends on the driving speed. The calibration value of the integration function, the speed interval of which includes the current speed of the vehicle, or a total calibration value determined as a function of said calibration value is subsequently introduced to the manipulated variable. The advantage of using a plurality of calibration functions or a bank of calibration functions compared to using an individual calibration function is particularly evident when accelerating or braking and therefore when the speed ranges of the vehicle change frequently.

According to the disclosure, the total calibration value can be determined from two or more of the calibration values generated by the integrating functions in such a way that the total calibration value is steady over time even when changing between two or more of the speed intervals. In this way, jerky alterations in the calibration value introduced to the manipulated variable and, consequently, jerky interventions when changing the calibration functions as a result of a modification in the speed of the vehicle are avoided.

In one configuration, an integration value of the calibration function allocated to the calibration function can be determined by the calibration functions in each case by the integration over time of the lateral deviation error, wherein the integration values of the one or more integration functions in which the current speed lies outside of the respective speed interval are continuously adapted, in particular at a constant or a vehicle speed-dependent rate, to the integration value of the calibration function, in the speed interval of which the current speed of the vehicle lies.

In order to avoid that when using the function for automatic lane guidance, primarily in a narrow speed range, only a few calibration functions or only a single calibration function is/are correspondingly charged with the lateral deviation error and correspondingly only these ultimately correctly image the current offset situation, the inactive calibration functions which are not used at the current speed can also continue to integrate the current lateral deviation error over time. The integration values, that is to say, the integrator states of the calibration functions, which are assigned in each case to a range adjacent to the current speed range, are restricted, at most, to the value of the integration value of the calibration function assigned to the current speed range. In addition, the weighting factors or the coefficients of integration of the calibration functions assigned to non-current speed ranges can advantageously be reduced compared to the active case, since if the coefficients of integration remain unmodified, the advantage of subdividing into multiple integrator states would disappear. The extent to which the adjacent coefficients of integration are reduced depends on the expected maximum sensor drift amounts and lies, for example, in the order of 10% to 20%. As a result, it can be avoided that the states of the inactive calibration functions increasingly lose their relevance due to the typical drift of the offset variables for curvature, yaw rate and lateral acceleration and that, as a result, a larger lateral deviation error and a reduced ride comfort are temporarily caused when entering an adjacent speed range until the adaptation to the current offset situation is completed.

The continuous adaptation of the integration values of the one or more integration functions in which the current speed lies outside of the respective speed interval, in particular at a constant or a vehicle speed-dependent rate, to the integration value of the calibration function, in the speed interval of which the current speed of the vehicle lies, can be deemed to be the implementing of a forgetting factor. The states of the inactive calibration functions approach the state of the currently active calibration function, by way of example with a uniform gradient or with a specified gradient which is individually fixed for the respective speed range.

For a controller for generating a manipulated variable for at least one lateral guidance actuator of a vehicle, it is provided that the controller is set up to perform a method as described herein. The controller can likewise be set up to perform the lateral control, to determine the target trajectory and/or to perform curvature pre-control. Alternatively, the controller can only implement some of these functions. The controller can be connected to at least one sensor of the vehicle, in particular at least one surroundings sensor which at least partly detects the vehicle's environment and/or at least one speed sensor which detects the speed of the vehicle, and/or a navigation system of the vehicle.

A vehicle may include at least one lateral guidance actuator as well as a controller, wherein the controller is set up to actuate the at least one lateral guidance actuator with the manipulated variable. The lateral guidance actuator can be, by way of example, a steering actuator, for example an electric servo drive of front axle steering and/or rear axle steering.

A computer program may include instructions which prompt a control device to carry out a method as described herein. The control device can in particular be a controller which can be connected to at least one lateral guidance actuator of a vehicle.

All of the advantages and configurations described above in relation to the method also apply to the controller described herein, the vehicle described herein, as well as the computer program described herein and vice versa in each case.

### BRIEF DESCRIPTION OF THE DRAWINGS

Further advantages and details of the disclosure are set out by the exemplary embodiments described below as well as based on the drawings. These are schematic representations, wherein:

FIG. 1 shows an exemplary embodiment of a motor vehicle according to one embodiment,

FIG. 2 shows a block diagram of an exemplary embodiment of a method for guiding a vehicle, and

FIG. 3 shows a block diagram of multiple calibration functions of an exemplary embodiment of the method.

### DETAILED DESCRIPTION

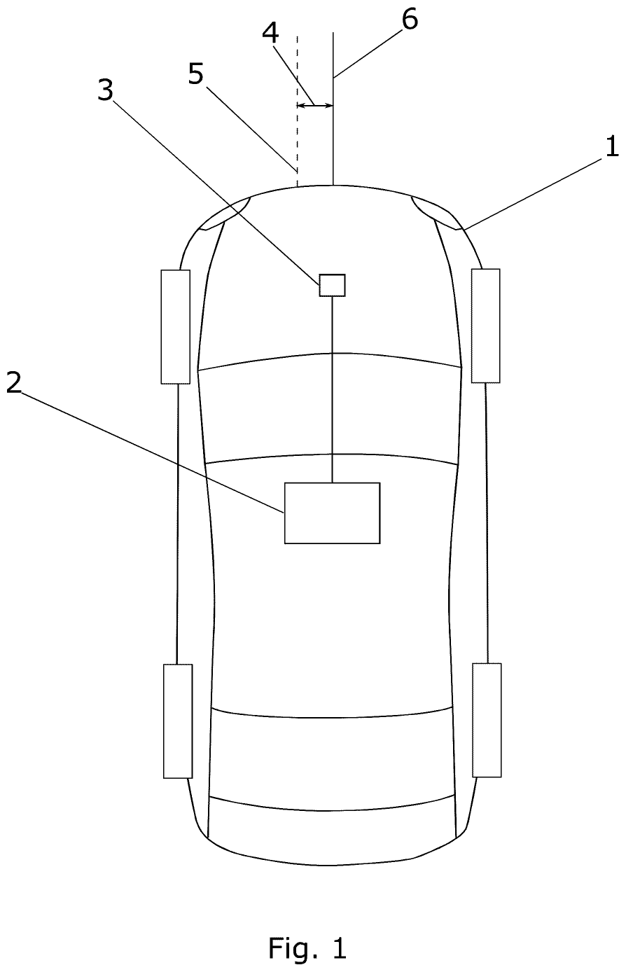

An exemplary embodiment of a vehicle 1 is shown in FIG. 1. The vehicle 1 can be, for example, a motor vehicle such as a passenger car or a truck. Furthermore, the vehicle 1 can also be a vehicle-trailer combination which has, for example, a towing vehicle as well as one or more trailers. Alternatively, the method can also be deployed in the case of further types of vehicles 1.

The vehicle 1 includes a control device 2 which is set up to perform a method for guiding the vehicle 1. Furthermore, the vehicle 1 includes at least one lateral guidance actuator 3, via which the lateral position of the vehicle 1 can be set.

The lateral guidance actuator 3 is, by way of example, embodied as a steering actuator, by means of which a front axle steering angle of the vehicle 1 can be set automatically. The steering actuator can be embodied, by way of example, as an electric servo drive. Additionally or alternatively, the or a further lateral guidance actuator 3 can also be a steering actuator for automatically setting a rear axle steering angle.

The control device 2 is set up to determine a manipulated variable by a lateral control as a function of a lateral deviation error which describes a lateral offset 4 of the vehicle 1 relative to a specified target trajectory 5 (depicted in dashed lines), and to adjust a lateral position of the vehicle 1 to the target trajectory 5 as a function of the manipulated variable. To this end, the control device 2 actuates the lateral guidance actuator 3 with the manipulated variable. The lateral offset 4 describes, by way of example, the deviation between the target trajectory 5 based on the center of the vehicle 1 and the actual direction of movement 6 of the center of the vehicle in the lateral direction of the vehicle.

The deviation from the target trajectory can, as depicted in FIG. 1, be established at a defined distance from the front edge of the vehicle 1 (forecast length), but also at further reference points. Further possible reference points lie, for example, at the height of the rear axle or of the front axle of the vehicle 1. The reference points may lie on the longitudinal axis of the vehicle; however, other reference points of the vehicle 1 which are locally fixed during the observation period are also conceivable.

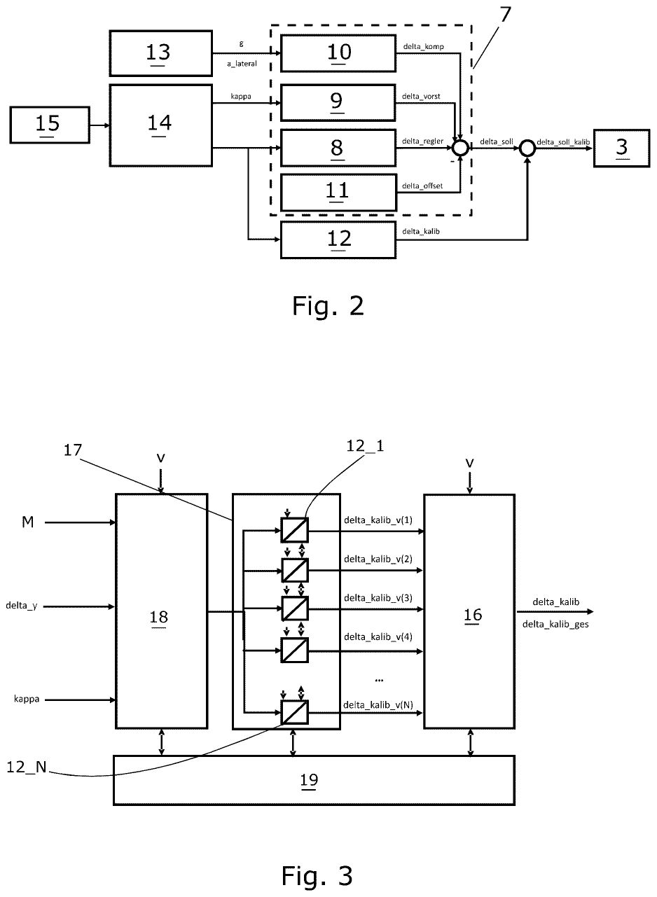

A block diagram of the exemplary embodiment of the method for guiding the vehicle 1 in an automated manner performed by the control device 2 is depicted in FIG. 2. The automatic lane guidance includes a lateral control 7 which regulates the lateral position of the vehicle 1 in order to comply with the target trajectory 4. The lateral control 7 generates a manipulated variable delta_soll for the lateral guidance actuator 3 which can be actuated, by way of example, directly or via an interposed steering angle controller (not depicted).

The lateral control 7 includes, for generating the manipulated variable delta_soll, a trajectory tracking controller 8, a curvature pre-control 9, one or more disturbance compensators 10, for example for compensating for crosswinds, road incline and/or further effects, as well as a steering angle offset calibration 11. A manipulated variable component delta_regler is determined by means of the trajectory tracking controller 8.

The curvature pre-control 9 determines a pre-control variable delta_vorst as a function of a measured and/or predicted curvature value of a road used by the vehicle 1, wherein the manipulated variable delta_soll contains the pre-control variable delta_vorst as a manipulated variable component. Correspondingly, one or more manipulated variable components delta_komp are generated via the one or more disturbance compensators 10, and a manipulated variable component delta_offset is generated via the steering angle offset calibration 11.

Furthermore, at least one calibration function 12 is provided, which determines a calibration value delta_kalib. The calibration value delta_kalib is applied to the manipulated variable delta_soll generated by the lateral control 7. A yaw rate g as well as a lateral acceleration a_lateral of the vehicle 1 are communicated by the signal processing 13 to the at least one disturbance compensator 10 as input variables. To this end, the signal processing 13 can evaluate measured values which are detected with the aid of different sensors of the vehicle 1 and which describe a yaw rate and/or a lateral acceleration.

A lateral deviation error delta_y is fed to the calibration function 12 as well as to the trajectory tracking controller 8 by a position recognition and trajectory planning unit 14. The lateral deviation error delta_y describes the lateral offset 4 between the target trajectory 5 and the actual direction of movement 6 or the actual position of the vehicle 1, which is shown in FIG. 1.

Furthermore, the position recognition and trajectory planning unit 14 provides the curvature pre-control 9 with at least one measured and/or predicted curvature information kappa, which describes the curvature of the target trajectory 5 in a section of the target trajectory 5 which lies in front of the vehicle 1 in the direction of travel. The position recognition and trajectory planning unit 14 determines the target trajectory 5 and, correspondingly, also the curvature information kappa as a function of environmental data which are provided by an environment detection unit 15 of the vehicle 1. The environment detection unit 15 generates the environmental data as a function of environmental measurement data which are generated in particular by at least one environmental sensor (not depicted) which detects at least one partial region of the environment of the vehicle 1.

The functionality of the blocks 8 to 15 can be implemented entirely or partly in the control device 7. The output variables of the blocks 8 to 11 represent all the components of the manipulated variable delta_soll. Furthermore, the at least one calibration value delta_kalib of the calibration function 12 is applied to the manipulated variable delta_soll.

The individual components of the manipulated variable delta_soll as well as the at least one calibration value delta_kalib have different effects on the lane guidance of the vehicle 1, which are described below.

The target steering angle component delta_vorst of the curvature pre-control 9 is calculated, by way of example, as

delta_vorst=kappa*(l+EG*v\hat{ }2), (1)

wherein the parameter I corresponds to the wheelbase and EG corresponds to the inherent steering gradient of the vehicle 1. The inherent steering gradient depends via

EG=m*(ch*lh−cv*lv)/(ch*cv*(lh+lv)) (2)

on the distance between the center of gravity and a front axle lv or a rear axle lh of the vehicle 1, on the vehicle mass m of the vehicle 1 and the slip stiffness of the tires at the front cv and rear ch.

If the curvature information kappa now has an offset kappa_offs compared to the actual curvature due to an error, the pre-controlled target steering angle likewise contains an offset proportion delta_vorst_kappaoff, which is given by

delta_vorst_kappaoff=kappa_offs*(1+EG*v\hat{ }2) (3)

The consequence of the pre-control value delta_vorst which contains errors with delta_vorst_kappaoff is that said value acts, so to speak, as a disturbance on the lateral control 7 and the vehicle 1 does not follow the target trajectory 5 as expected when lane-keeping assistance is activated, but rather, depending on the embodiment of the trajectory tracking controller 8—i.e., use of controller types with or without stationary accuracy—has a permanent lateral offset 4 relative to the planned target trajectory 5 or at least causes a transient veering-out before the vehicle 1 then follows the planned target trajectory 5 after an equalization process has subsided.

As a general rule, the degree of the imaging errors of a camera deployed as an environment sensor, which supplies environmental measurement data to the position recognition and trajectory planning unit 14, varies over the service life of the driver assistance system, since calibration routines of the camera are typically carried out continuously. This means that, depending on the status of the calibration, the level of the offset of the curvature pre-control 9 and, therefore, the degree of the adverse effect of the vehicle lateral guidance are time-variant, even though the transmission properties of the camera and, therefore, also the offset of the curvature do not, for the most part, alter by leaps and bounds, but rather in a band-limited manner.

It is possible that the steering angle is used as an auxiliary or control variable within a lane guidance driver assistance system. Said steering angle can be influenced or corrected by the steering angle calibration routine 11. As a general rule, a determined steering angle offset delta_offset has an uncompensated proportion due to the finite accuracy of the steering angle calibration routine 11.

A remaining offset error delta_offset_error in the steering angle signal can have multiple causes. Typically, a steering angle calibration routine 11 mostly relies on the signal from a yaw rate sensor of the vehicle 1 and/or wheel speed sensor technology of the vehicle 1. Errors in these sensors such as, for example, offset and linearity errors, can consequently propagate towards the determined steering angle offset. The effects of steering angle offsets can be compared to the case of a curvature offset described above; here as well, when the lane guidance driver assistance system is activated, the vehicle 1 does not follow the target trajectory 5 as expected, but rather has a permanent or transient lateral offset 4, depending on the embodiment of the trajectory tracking controller 8, relative to the planned target trajectory 5, which can be associated with detrimental effects on the comfort and the acceptance of the driver assistance system.

If, for example, a PD controller is used as the trajectory tracking controller 8, which has the transfer function

Gr(s)=Kp(v)+s*Kd(v)/(1+s*T), (4)

and the speed-dependent controller factors Kp(v) and Kd(v), this results in the lateral deviation error delta_y, which describes the lateral offset 4, as the input variable and in delta_regler as the output variable of the trajectory tracking controller 8

delta_regler(s)=Gr(s)*delta_y(s). (5)

Hence, the trajectory tracking controller 8 will output the uncompensated steering angle offset delta_offset_error in the stationary state of equilibrium when driving straight ahead, i.e., with a physical steering angle of zero degrees, and neglecting lateral disturbing forces on the vehicle 1. The lateral offset 4 necessary for this is produced via

Delta_y(0)*Gr(0)=Delta_offset_error(0) (6)

as

delta_y=delta_offset_error/Kp(v) (7)

in the time range. The controller factor Kp cannot be chosen to be any desired size during the design, as a result of which, if an uncompensated steering angle offset delta_offset_error does not equal zero, a lateral offset 4 of the vehicle 1 relative to the target trajectory 5 is constantly formed. An uncompensated offset of a rear axle steering angle during rear axle steering of the vehicle 1 has a comparable effect on the lateral offset 4 of the vehicle 1 to an uncompensated offset of the front axle steering angle.

The sensor signals for the yaw rate, the front and rear axle steering angle and also the lateral acceleration are also used in particular to estimate disturbing forces and load torques which act on the vehicle 1, for example as a consequence of a road incline and/or crosswind acting on the vehicle 1. The determined forces and torques then contribute proportionally to the steering angle target value delta_soll in the course of the introduction of the disturbance variable input delta_komp.

Furthermore, the sensors can also be used to estimate a slip angle of the vehicle 1, which can likewise be used as an auxiliary variable in the load estimates. Offset errors in the yaw rate g, the steering angle or the lateral acceleration a_lateral frequently have an action on the estimated variables and therefore also on the introduction of the disturbance variables, which is proportional to the respective offset in a stationary case. Hence, offset errors in the yaw rate g, the steering angle and also the lateral acceleration a_lateral propagate to the disturbance-compensating proportion of the steering angle target value delta_soll. Here as well, the consequence is an undesirable transient or permanent lateral offset of the guided vehicle 1 relative to the planned target trajectory 5. As a general rule, disturbance compensators 10 for the yaw rate g and the lateral acceleration a_lateral also have, similarly to the steering angle compensation 11, a finite accuracy and can thus lag behind the real offset, as a result of which the previously described detrimental effects on the ride comfort of the vehicle 1 can become apparent even in the presence of this when using the lane guidance driver assistance system.

Said effects are addressed and at least partly compensated for by the at least one calibration function 12, which results in an improved ride comfort of the vehicle 1. The calibration function 12 is superimposed on the lateral control 7 and generates the at least one calibration value delta_kalib applied to the manipulated variable delta_soll. The calibration value delta_kalib is determined by the at least one calibration function 12 at least partly as a function of an integration over time of the lateral deviation error delta_y.

That is to say that, depending on the algebraic sign and the amplitude of the lateral deviation error delta_kalib, a calibration value delta_kalib is determined by the calibration function 12 for the target steering angle delta_soll which is constantly aimed at reducing the lateral deviation error delta_y, in particular with regard to the effective direction. Said calibration value delta_kalib is then finally added to the manipulated variable delta_soll from the manipulated variable components of the trajectory tracking controller 8, the curvature pre-control 9, the one or more disturbance compensators 10 and the output of the steering angle offset calibration 11 and is introduced, as a calibrated manipulated variable delta_soll_kalib, for example, to a target steering angle interface of the lateral guidance actuator 3. Alternatively, it is also possible to introduce the calibrated manipulated variable to a torque interface of the lateral guidance actuator 3.

The calibration function 12 can, by way of example, be embodied as an integrator or as an I element having a comparatively small integration coefficient ki, so that the calibration function 12 integrates the lateral deviation error with low dynamics. Alternatively, it is also possible to realize the calibration function as a PT1 element or as a different function with an at least partly integrating behavior.

The determination of the calibration value delta_kalib by the calibration function 12 can thus be expressed, by way of example, as follows, when the calibration function 12 is embodied as an integrator with the coefficient of integration ki,

Delta_kalib=Delta_y*ki/s (8)

The time constant of the calibration function 12 is in particular larger than the dominant time constant of the lateral control 7 or of the trajectory tracking controller 8 by at least a factor of 2, at least a factor of 5, at least a factor of 10, at least a factor of 100 or at least a factor of 1000. To that end, the integration coefficient ki lies, for example, in the order of 0.001 degrees/(m*s), so that the gradient of the calibration value 12 is only 0.0002 degrees in the case of a lateral deviation error delta_y of 0.2 m which is assumed as an example for illustration purposes.

The adaptation dynamics of the calibration value 12 may be dimensioned such that it lies in the order of magnitude of the alteration dynamics of the offset errors described above. A measure of this is, for example, the largest expected, temperature-related offset drift of the sensors used for the lateral control 7, for example converted to the corresponding steering angle plane. If the dynamics were chosen to be significantly larger, a typical overshoot would arise in the signal for delta_kalib, since the calibration would then partly compete with the transient response of the compensation functions 10 for road side inclination or crosswind. However, this could again have a limiting effect on the increase in comfort through the calibration function 12.

The calibration function 12 determines an integration value of the calibration function 12 by the integration over time of the lateral deviation error delta_y. Said integration value represents the result of the integration over time of the lateral deviation error delta_y at a specific point in time. The integration value is retained when the lane guidance is deactivated and is used as the starting value of the renewed integration over time of the lateral deviation error delta_y when the lane guidance is reactivated. That is to say that the state of the calibration function 12 which is, for example, embodied as an integrator is not reset in the current ignition cycle, but rather is maintained even when the driver assistance is repeatedly deactivated and activated, when the journey is ended and/or when driver interventions overwrite the automatic lane guidance.

The use of a constant integration coefficient ki in the calibration function 12 can represent a compromise for the entire speed range which can be reached by the vehicle 1, since the influence of offset variables on the lateral deviation error delta_y can be dependent on the driving speed. This can be due, for example, to the commonly used controller parameter control of the trajectory tracking controller 8 as a function of the driving speed. As a result, the disturbance compensation property of the trajectory tracking controller 8 also alters and, hence, also the effect of sensor offset variables on the lateral deviation error delta_y.

In order to take account of this circumstance and to extend the potential of the calibration function, it can be provided that the integration over time of the lateral deviation error delta_y is effected with a weighting factor, in particular the coefficient of integration ki, which depends on a speed of the vehicle. That is to say that the integration coefficient ki can be made dependent on the current speed of the vehicle 1 as ki(v). This advantageously brings about individually adaptable calibration dynamics of the calibration function 12 which are ideal for every driving speed range.

Additionally or alternatively, it can be provided that the weighting factor or the coefficient of integration ki increases as the amount of the lateral deviation error delta_y rises. The calibration speed of the calibration function 12 can be effectively increased by an additional non-linear or progressive weighting of the amount of the lateral deviation error delta_y.

To this end, the integration coefficient ki and, therefore, the adaptation rate are, for example, switched over between two or more values, wherein the integration coefficient ki is chosen to be higher for larger absolute values of the lateral deviation error delta_y. By way of example, doubling the integration constant ki for an amount of the lateral deviation error delta_y of, for example, larger than 0.2 m can lead to a faster initial adaptation to an existing offset situation when the driver assistance function is started.

Even when the sensor compensators 10 and/or further sensor offset calibration functions in the vehicle 1 finally remedy a recognized offset drift of a sensor after a debounce time has elapsed with a sudden correction of the respective offset, a definition of the adaptation rate of the calibration function 12 can, as a function of the amount of the lateral deviation error delta_y, ensure a faster alignment to the new offset situation. This is particularly advantageous for comparatively long debounce times of the sensor compensators 10 or further sensor offset calibration functions since, during such a debounce time, the calibration function 12 already increasingly conducts a compensation, which must be integrated back again after a signal update of the sensor compensators or sensor offset calibration functions.

Since sudden corrections of a sensor offset immediately lead to a lateral jerk of the vehicle 1, which depends on the jump height, it can be provided as an advantageous extension that all of the sensor offset calibration functions in the vehicle 1 do not make an alteration to the respective sensor offset suddenly, but rather only in a band-limited manner. For example, if the offset compensations for the vehicle sensors happen at most with a defined maximum gradient which the output of the centering calibration delta_kalib can constantly follow with a small lag error of the order of 0.03 degrees, then the non-linear or progressive weighting of the amount of the lateral deviation error delta_y can also be dispensed with in the calibration function 12 as a measure for increasing the dynamics.

Furthermore, the contribution of delta_kalib to the total manipulated variable delta_soll_kalib is advantageously limited in its maximum amplitude by a limitation of the integrator state in the calibration function 12. To this end, it can be provided that the integration over time of the lateral deviation error delta_y by the calibration function 12 is stopped when the or an integration value of the calibration function 12 determined by the integration over time of the lateral deviation error delta_y corresponds to a specified limit value.

The limit value or the maximum amplitude of the integrator or of the calibration function 12 is governed, for example, by the sum of the maximum influences of all offset variables on the steering angle target value delta_soll and the actual steering angle value. If, for example, delta_komp, delta_vorst and delta_offset have a maximum offset error of, in each case, 0.05 degrees, then delta_kalib is to be restricted to an interval of +/−0.15 degrees. The angle details refer to the steering angle of the vehicle, for example a steering angle at the front wheels of the vehicle. In the case of said procedure, the otherwise necessary measures for avoiding integrator windup effects in the calibration function 12 can also be advantageously omitted.

Alternatively to limiting the integrator state, a low-pass filter function can also be used, for example a PT−1 filter. As a result, windup effects can also be avoided. It is true that the offset situation cannot be completely eliminated, the centering accuracy achieved can nevertheless be sufficient.

During cornering, the lateral deviation error as a consequence of a pre-control error depends not only on an offset error in the curvature, but rather also on the inaccuracy of the saved vehicle parameters, in particular on uncertainties in the inherent steering gradient EG. The proportion of the erroneous pre-control as a consequence of errors in the inherent steering gradient EG is produced by applying the total differential to equation (1) and evaluating for EG or its error EG_err as

$$\begin{matrix}delta\_vorst \_EG \_err = ( d delta\_vorst / d EG ) * EG\_err \\ = ( d ( kappa * ( l + EG * v \hat{} 2 ) ) / d EG ) * EG\_err \\ = kappa * v \hat{} 2 * EG\_err\end{matrix} \qquad ( 8 )$$

Contributions of delta_vorst_EG_err have the effect of a disturbance on the lateral control of the vehicle 1 and proportionally cause a lateral deviation error delta_y, which leads to an erroneous deflection of delta_kalib. Therefore, the delta_kalib signal does not only react to sensor offset amounts. As long as EG_err is limited, the effect of EG_err on the vehicle plane is, however, only small due to the large integration time constant of the centering calibration. The integration time constant is defined as the reciprocal of the coefficient of integration ki.

This also therefore applies since an erroneous deflection of delta_kalib in curves on the straight-ahead passages of the road is corrected again. If EG_err varies to a greater extent, the value for EG in the vehicle can be continuously adapted to the current circumstances such as vehicle mass m or tire stiffnesses by an adaptation algorithm as remedial action, as a result of which EG_err falls and, therefore, also the contribution of delta_vorst_EG_err.

Furthermore, in the case of a larger variation of EG_err, the calibration function 12 can be suspended at high values for the product kappa*v\hat{ }2. That is to say, it can be provided that the integration over time of the lateral deviation error delta_y by the calibration function 12 is stopped when the product of the square of the current vehicle speed v and of the curvature value kappa of the target trajectory 5 and/or of the curvature value of the road exceeds a specified threshold.

To this end, the curvature kappa is advantageously initially low-pass filtered, for example by means of the PT−1 algorithm, and then the absolute value is subjected to a threshold comparison which is dependent on the driving speed v. If the filtered curvature is above said threshold, the calibration function 12 is temporarily stopped.

Furthermore, it can be provided that the integration over time of the lateral deviation error delta_y by the calibration function 12 is stopped when the or a measured and/or predicted curvature value kappa of the or of a road used by the vehicle 1 exceeds a specified threshold and/or if a curvature value of the target trajectory 5 exceeds a specified threshold.

If the curvature for its part temporarily has a larger offset error until the camera calibration has compensated for said error, this can temporarily reduce the calibration activity of the calibration function 12 for higher driving speeds. However, the adaptation range is only displaced by the measure of the curvature offset, so that the calibration activity does not come to a complete standstill. In addition, if the driving speed v is reduced and the product kappa*v\hat{ }2 is therefore reduced, the calibration is carried out again more intensively.

Disturbances in the calibration can in particular also be caused by the driver making interventions and who can directly influence the lateral deviation error delta_y, for example by steering a steering wheel of the vehicle 1. To remedy this, the calibration function 12, i.e., the integration of the lateral deviation error delta_y, can be stopped when the driver intervenes at the steering wheel. In particular, it is possible that the integration over time of the lateral deviation error delta_y is stopped and/or that the application of the calibration value delta_kalib to the manipulated variable delta_soll is suspended if, due to a steering intervention by a driver of the vehicle 1, a steering torque M above a specified threshold is generated and/or a steering torque M enlarging the current lateral deviation error delta_y is generated.

However, a higher availability and, therefore, also a faster convergence of the calibration function 12 can be achieved by only stopping the calibration function 12 when the driver steers in the direction of an enlargement in the lateral deviation error delta_y. This can happen by comparing the algebraic sign of the driver's steering torque M and the lateral deviation error delta y. If, by way of example, the directional arrow of the driver's steering torque M is defined in such a way that steering to the left in the direction of travel causes a positive torque and a positive lateral deviation error means the positioning of the vehicle to the right of the planned target trajectory 5 in the direction of travel, then the algebraic signs of the driver steering torque M and the lateral deviation error must be different as the stop condition of the calibration function.

The integration coefficient ki is initially conducted for the embodiment of the lane assistance for steering interventions by the driver below a defined intensity, evaluated, for example, based on the level of the measured driver steering torque M. Additionally or alternatively, it can be provided that during a steering intervention by a driver of the vehicle 1 which generates a steering torque M which reduces the current lateral deviation error delta_y the integration over time of the lateral deviation error delta_y is effected at least for a specified period of time with an increased weighting, in particular with an increased coefficient of integration. As a result, the integration coefficient can be deliberately raised compared to the basic design when a driver intervention is recognized and the driver simultaneously steers in the direction of a decrease in the lateral deviation error delta_y. The driver's steering can be deemed to be a confirmation of the calibration process of the calibration function 12, which justifies a rise in the calibration dynamics by raising the coefficient of integration ki.

As described, the effect of offset variables on the lateral deviation error delta_y is partly dependent on the driving speed v. This applies, for example, to the offset errors which are contained in the output of the disturbance compensators delta_komp, or the offset error which is an integral part of the curvature pre-control delta_vorst. Thus, when the driving speed alters, delta_kalib must constantly alter as well in order to keep the lateral deviation error low, although the offset variables in yaw rate g, lateral acceleration a_lateral and pre-control curvature kappa which are the cause of the lateral deviation error are assumed to be constant in the analysis. Due to the high integration time constant of the calibration function 12 and, therefore, the low dynamics of the calibration function 12, the adaptation to the altered driving speed v takes a relatively long time, during which the accuracy of the lane guidance is reduced.

In order to take account of this circumstance, it is advantageous to use an arrangement of multiple integrators or memories instead of an individual integrator as a memory for delta_kalib for the entire vehicle speed range, as depicted, for example, in FIG. 3.

The use of multiple integrating functions 12_1 to 12_N is depicted in FIG. 3. Further, an interpolation unit 16, an initialization unit 17, an integration coefficient establishing unit 18 as well as a sequencing control unit 19 are illustrated as part of the control device 2.

A different speed interval is assigned to each of the integrating functions 12_1 to 12_N, wherein the integrating functions 12_1 to 12_N each integrate the lateral deviation error delta_y over time at a speed of the vehicle 1 which lies within the speed interval assigned to each of them. That is to say that the entire range of the vehicle speed is subdivided into N>1 sub-intervals which only cover a limited speed range in each case and to which a calibration function 12 or a dedicated integrator is allocated in each case. Consequently, only an individual calibration function 12 is constantly active at one point in time, while the remaining calibration functions 12 are stopped or an input signal of zero is introduced to their inputs. By contrast, the calibration function which is active in each case, calibration function 12_1 to 12_N, is supplied with the weighted lateral deviation error delta_y and each integrator generates its own delta_kalib_v(k), k=[1 . . . . N]. The calibration value delta_kalib_v(1) to delta_kalib_v(N) of the respective calibration function 12_1 to 12_N, the speed interval of which includes the current speed of the vehicle 1, can be introduced directly to the manipulated variable delta_soll as the resulting delta_kalib. The weighting of the lateral deviation error delta_y can in each case be effected with a constant coefficient of integration ki or via a factor ki(v) which depends on the driving speed.

The coefficient of integration ki or ki(v) can be determined for the individual calibration functions 12_1 to 12_N by the integration coefficient establishing unit 18. To this end, the integration coefficient establishing device 18 can receive, as input variables, by way of example, the vehicle speed v, the steering torque M of a driver of the vehicle 1, the current lateral deviation error delta_y as well as the measured or predicted curvature kappa.

The centers of the N vehicle speed intervals represent, so to speak, the supporting points for the output values delta_kalib_v(k). In order to now obtain a resulting delta_kalib from the individual contributions delta_kalib_v(k), a total calibration value delta_kalib_ges determined by the interpolation unit 16 from the calibration values delta_kalib_v(1) to delta_kalib_v(N) can additionally or alternatively be introduced to the manipulated variable delta_soll. The total calibration value delta_kalib_ges is in particular determined from two or more of the calibration values delta_kalib_v(1) to delta_kalib_v(N) generated by the integrating functions 12 in such a way that the total calibration value delta_kalib_ges is consistent over time even when changing between two or more of the speed intervals. This can be implemented, for example, by the interpolation unit 16 via a linear interpolation, wherein the interpolation unit receives the vehicle speed v as an input variable.

To this end, by way of example, as a function of the two distances between the current driving speed and the two centers of adjacent speed ranges, delta_kalib_ges from delta_kalib_v(k) and delta_kalib_v(k+1) are linearly combined. The following applies

delta_kalib_ges=delta_kalib_v(k)*a+delta_kalib_v(k+1)*(1−a) (9)

where

a=(v−v(k))/(v(k+1)−v(k)),v>v(k),v<v(k+1)

An interpolation between the individual integrator states delta_kalib_v(k) is also advantageous for the reason that no jump from delta_kalib_ges occurs during a transition from one speed range to another. Jumps in the steering angle target value delta_soll_kalib lead to a lateral jerk of the vehicle 1 and are to be avoided for reasons of ride comfort. The advantage of using a bank of calibration functions 12_1 to 12_N or a bank of integrators compared to using an individual integrator becomes especially evident during accelerating or braking and, therefore, the frequent change of speed ranges.

If the driver assistance function is predominantly operated in a narrow speed range, the case can occur that only one of the calibration functions 12 is charged in accordance with the lateral deviation error delta_y, so that only said calibration function 12 correctly images the current offset situation. Due to the typical drift of the offset variables for curvature kappa, yaw rate g and lateral acceleration a_lateral, the states of the remaining integrators increasingly lose their relevance.

When entering an adjacent speed range, a larger lateral deviation error delta_y and, simultaneously, reduced ride comfort could then temporarily occur until the adaptation to the current offset situation is concluded. As remedial action, a forgetting factor can advantageously be implemented. To this end, it can be provided that an integration value of the calibration function 12_1 to 12_N allocated to the calibration function 12_1 to 12_N is determined by the calibration functions 12_1 to 12_N in each case by the integration over time of the lateral deviation error, wherein the integration values of the one or more integration functions in which the current speed lies outside of the respective speed interval, is continuously adapted, in particular at a constant or a vehicle speed-dependent rate, to the integration value of that calibration function 12_1 to 12_N, in the speed interval of which the current speed of the vehicle 1 lies.

In this case, for example, all of the integrator states or integration values of the inactive calibration functions 12_1 to 12_N strive for the state or the integration value of the currently active calibration function 12_1 to 12_N with a uniform gradient or a specified gradient which is individually fixed for the respective speed range. Said gradient can, by way of example, be governed by the alteration dynamics of the offset amounts. In the application, it can advantageously be dimensioned so that it corresponds to 25% of the resulting gradient for delta_kalib_v(k) for a lateral deviation error of 0.2 m. If the aligning gradient is chosen to be too high, the advantage of using a bank of calibration functions 12_1 to 12_N compared to using an individual calibration function 12 disappears.

Alternatively to the gradient method carried out, the calibration functions of the currently irrelevant speed ranges can be further carried out with coefficients of integration reduced, for example, to 10% to 20%. In the case of this approach, the integrator states exceeding the integrator state of the currently active speed range is avoided by corresponding limitations.

Depending on the dynamics of the offset influences, it can be advantageous to write the state of an individual calibration function 12 or all of the states of a plurality of calibration functions 12_1 to 12_N in a non-volatile memory, for example a memory of the control device 3, in order to be able to land on the already calibrated states of the one or more calibration functions 12 or 12_1 to 12_N when the ignition of the vehicle 1 is restarted. In particular, this is advantageous when the largest proportion of the offset errors do not have any time drift or only have a small time drift.

The states or the integrating values of the one or more calibration functions 12_1 to 12_N can be stored by the initialization unit 17. Furthermore, the initialization unit 17 can also initialize the calibration functions 12_1 to 12_N as well as perform a state reconciliation between the calibration functions 12_1 to 12_N or their current integration values.

The sequencing control unit 19 can, for example, reproduce an activation and/or a deactivation of the automatic lane guidance, the occurrence of a condition for stopping an integration over time and/or, in order to apply the at least one calibration value delta_kalib to the manipulated variable delta_soll, reproduce the change between the speed intervals and/or further events and to correspondingly bring about operation of the at least one calibration function 12.

In its fundamental function, the calibration function 12 can also be deemed to be a form of an integral proportion in the trajectory tracking controller 8, however it may have the significant properties or the significant differences that the integration coefficient or another weighting factor used for the integration over time of the lateral deviation error delta_y is very low, contrary to the typical design criteria for a lateral control 7, and/or that the calibration function 12 or the integration over time of the lateral deviation error delta_y is not initialized with zero when the assistance system is restarted, but rather lands on the last state reached or assumes the latter. The advantage of this is that the vehicle 1 has no lateral transient response, so to speak, when the driver assistance function is activated, but rather can drive directly along the planned target trajectory 5. The extensions of the at least one calibration function 12 described above also represent further differences to a classic integral proportion of a lateral guidance controller.

The at least one calibration function 12 can be embodied as a separate function or, alternatively, can also be implemented additionally to an already existing integral proportion in the trajectory tracking controller 8. The at least one calibration function 12 will in particular only make an adaptation in the activation phases of the driver assistance system until the integral proportion of the trajectory tracking controller 8 has reduced the lateral deviation error delta_y to zero or whenever the integral proportion of the trajectory tracking controller 8 is reset and has to build itself up again. This can occur, for example, for an autonomously driving vehicle according to Level 2 when the driver steers.

In general, the calibration dynamics of the calibration function 12, i.e., the time required until an adaptation of the lateral offset 4 of the vehicle 1 to the current offset situation has taken place, can be larger than in the case of a driver assistance system without an integral proportion in the trajectory tracking controller 8. This circumstance can be at least partly countered by raising the coefficient of integration or the coefficients of integration when using the one or more calibration functions 12 with a trajectory tracking controller without an integral proportion. Furthermore, when using an integral proportion in the trajectory tracking controller 8, one or more of the disturbance compensations 10 for crosswind and/or road incline can be dispensed with. The consequence of this is that a significant source of offset errors is also eliminated and, consequently, fewer offset effects have to be considered by the calibration function 12, which advantageously has the consequence of a lower requirement for the calibration dynamics of the at least one calibration function 12.

1-16. (canceled)

17. A method for automatically guiding a vehicle, comprising:
determining a manipulated variable with a lateral control as a function of a lateral deviation error which describes a lateral offset of the vehicle relative to a specified target trajectory;
adjusting a lateral position of the vehicle to the target trajectory as a function of the manipulated variable;
additionally applying a calibration value to the manipulated variable; and
determining the calibration value by a calibration function at least partly as a function of an integration over time of the lateral deviation error.

18. The method according to claim 17, wherein a time constant of the calibration function is larger than the dominant time constant of the lateral control by at least by a factor of 2.

19. The method according to claim 17, further comprising determining an integration value of the calibration function by the integration over time of the lateral deviation error, wherein the integration value is retained when the lane guidance is deactivated and is used as the starting value of the integration over time of the lateral deviation error when the lane guidance is reactivated.

20. The method according to claim 17, wherein the lateral control comprises a pre-control, wherein the pre-control determines a pre-control variable as a function of a measured and/or predicted curvature value of a road used by the vehicle, and wherein the manipulated variable includes the pre-control variable as a component.

21. The method according to claim 20, wherein the pre-control is effected as a function of a vehicle model which describes an inherent steering gradient of the vehicle, wherein the inherent steering gradient is adapted during the operation of the vehicle as a function of at least one vehicle parameter, the at least one vehicle parameter including at least one of a vehicle mass and a tire stiffness.

22. The method according to claim 17, the integration over time of the lateral deviation error is effected with a weighting factor, the weighting factor including a coefficient of integration which depends on a speed of the vehicle and/or increases as the amount of the lateral deviation error rises.

23. The method according to claim 17, further comprising stopping the integration over time of the lateral deviation error by the calibration function in response to at least one of:
the integration value of the calibration function determined by the integration over time of the lateral deviation error corresponding to a specified limit value;
a measured and/or predicted curvature value of a road used by the vehicle exceeding a specified threshold;
a curvature value of the target trajectory exceeding a specified threshold;
the product of the square of the current vehicle speed and the curvature value of the road exceeding a specified threshold; and
the product of the square of the current vehicle speed and the curvature value of the target trajectory exceeding a specified threshold.

24. The method according to claim 17, wherein the integration over time of the lateral deviation error is stopped and/or the application of the calibration value to the manipulated variable is suspended when a steering torque above a specified threshold is generated and/or a steering torque which enlarges the current lateral deviation error is generated by a steering intervention by a driver of the vehicle.

25. The method according to claim 17, during a steering intervention by a driver of the vehicle which generates a steering torque which reduces the current lateral deviation error the integration over time of the lateral deviation error is effected at least for a specified period of time with an increased weighting, in particular with an increased coefficient of integration.

26. The method according to claim 17, wherein multiple integrating functions are used, wherein a different speed interval is assigned to each of the integrating functions, wherein the integrating functions each integrate the lateral deviation error over time at a speed of the vehicle which lies within the speed interval assigned to each of them, wherein the calibration value of the integration function, the speed interval of which comprises the current speed of the vehicle, or a total calibration value determined as a function of said calibration value is introduced to the manipulated variable.

27. The method according to claim 26, wherein the total calibration value is determined from two or more of the calibration values generated by the integrating functions in such a way that the total calibration value is consistent over time even when changing between two or more of the speed intervals.

28. The method according to claim 26, wherein an integration value of the calibration function allocated to the calibration function is determined by the calibration functions in each case by the integration over time of the lateral deviation error, wherein the integration values of the one or more integration functions in which the current speed lies outside of the respective speed interval are continuously adapted, in particular at a constant or a vehicle speed-dependent rate, to the integration value of the calibration function, in the speed interval of which the current speed of the vehicle lies.

29. The method according to claim 17, wherein the at least one calibration function is in each case embodied as an I element or as a PT1 element.

30. A controller for generating a manipulated variable for at least one lateral guidance actuator of a vehicle, wherein the controller is set up to perform a method comprising:
determining a manipulated variable with a lateral control as a function of a lateral deviation error which describes a lateral offset of the vehicle relative to a specified target trajectory;
adjusting a lateral position of the vehicle to the target trajectory as a function of the manipulated variable;
additionally applying a calibration value to the manipulated variable; and
determining the calibration value by a calibration function at least partly as a function of an integration over time of the lateral deviation error.

31. A vehicle comprising:
at least one lateral guidance actuator; and
a controller configured to actuate the at least one lateral guidance actuator with a method including
determining a manipulated variable with a lateral control as a function of a lateral deviation error which describes a lateral offset of the vehicle relative to a specified target trajectory;
adjusting a lateral position of the vehicle to the target trajectory as a function of the manipulated variable;
additionally applying a calibration value to the manipulated variable; and
determining the calibration value by a calibration function at least partly as a function of an integration over time of the lateral deviation error.
